(19) United States
(12) Patent Application Publication
(10) Pub. No.: US 2026/0230476 A1
(43) Pub. Date: Aug. 6, 2026

(54) INTERMEDIATE OS USER ACCESS TO CLOUD CUSTOMER RESOURCES

(71) Applicant: Oracle International Corporation, Redwood Shores, CA (US)

(72) Inventors: Joydip Kundu, Nashua, NH (US); Ritesh Majumdar, Bengaluru (IN); Krishna Chander, San Ramon, CA (US)

(73) Assignee: Oracle International Corporation, Redwood Shores, CA (US)

(21) Appl. No.: 19/042,844

(22) Filed: Jan. 31, 2025

(51) Int. Cl. H04L 9/40; H04L 67/56

(52) U.S. Cl. CPC H04L 63/10; H04L 67/56

(57) ABSTRACT

Disclosed is an approach to use an intermediate OS (operating system) user to prevent lateral movement of cloud service operators among databases that share a database binary. Some approaches use an on-demand secure communications channel to access a cloud-related resource that is associated with a customer. This creates on a temporary basis the infrastructure (including the intermediate OS user) that is needed to allow the operational access to the customer system, which can then be destroyed once it is no longer needed.

### BACKGROUND

In a cloud computing environment, computing systems may be provided as a service to customers. One of the main reasons for the rising popularity of cloud computing is that the cloud computing model typically allows customers to avoid or minimize both the upfront costs and ongoing costs that are associated with maintenance of IT infrastructures. Moreover, the cloud computing paradigm permits high levels of flexibility for the customer with regards to its usage and consumption requirements for computing resources, since the customer only pays for the resources that it actually needs rather than investing in a massive data center infrastructure that may or may not actually be efficiently utilized at any given period of time.

The cloud resources may be used for any type of purpose or applicable usage configuration by a customer. For example, the cloud provider might host a large number of virtualized processing entities on behalf of the customer in the cloud infrastructure. The cloud provider may provide devices from within its own infrastructure location that are utilized by the cloud customers. In addition, the cloud provider may provide various services (e.g., database services) to customers from the cloud. As yet another example, the cloud provider may provide the underlying hardware device to the customer (e.g., where the device is located within the customer's own data center), but handle implementation and administration of the device as part of the cloud provider's cloud environment.

One of the main functions performed by the cloud provider in the cloud computing model is the administration and maintenance of the cloud computing resources. By having the administrative staff of the cloud provider take control over these administrative tasks, this minimizes the need and costs for the customer to maintain its own IT staffing and infrastructure to handle these tasks, which is in essence one of the main advantages of the cloud computing paradigm for customers. To perform these tasks, the typical scenario is for the cloud provider's administrative staff to have full and unfettered ability to access and perform administrative functions within the cloud resources.

Consider the scenario where the customer of the cloud provider installs a server or device at the customer's own on-premises location that is intended to be integrated in some way with the cloud environment and/or administratively managed by the cloud provider. For example, a customer may choose to purchase a “cloud in a box” device from a cloud provider, in which the device implements deployable hardware and software functionality in an integrated manner (e.g., a cloud in a box machine that hosts a cloud-based database management server), where the device may be configured to either integrate with the cloud-provider's cloud infrastructure or to function as a stand-alone device in the customer's own data center. In this situation, there may be frequent occasions where an operator from the cloud provider needs to access the on-premises device to perform various administrative operations. In the past this was achieved by maintaining a persistent channel over which the cloud provider's operations team is able to access the remote host that is within the customer's on-premises environment.

One significant problem with this approach is that it may be problematic for customers to allow an external party to have access into the customer's computing infrastructure of an extended and indeterminate length. Indeed, this approach raises concerns since the customers may not be able to choose or control the operational access to the hosts that are present in their data center. For instance, this may be particularly a problem for regulated customers (such as banks and medical providers) that need to comply with applicable contractual or legal requirements regarding responsibilities and obligations for strictly controlling the actions for access to their computing systems and data, where this responsibility is independent of the ownership of the equipment or the origin of the staff performing the actions on the equipment. Moreover, regulated customers often have to prove to their regulators that they are in complete control of these systems, and that they are operating their systems in compliance with those regulations. These requirements for the regulated customers may be in conflict with the conventional cloud computing scenario where the cloud provider's administrative operators and not the cloud customer—have significant control over access to some or all of the customer's infrastructure resources.

A particular situation where this problem may arise is in the scenario where a cloud provider implements a shared binary that is used to run multiple instances of the same software for a customer. This is especially useful for large scale mission critical software like relational database management software (RDBMS), where such a shared installation will reduce resource usage in terms of local storage needed to host the software image. Instead of requiring each database to have its own separate and distinct installation of the software, the cloud provider may instead choose to implement a shared binary for the software that is useable by multiple databases. Note such an optimization can also be employed where a single virtual machine (VM) is hosting multiple databases owned by multiple customers while the separate databases share the same RDBMS software binary.

This approach reduces the overhead of using excess resource redundancies, which is especially beneficial in systems that have limited quantities of local resources, such as storage and/or memory resources. However, such an approach creates possible security problems, especially for regulated customers, since the operator user that accesses the shared binary may end up being able to access content or resources that are owned by or dedicated to multiple different customers.

Therefore, there is a need for an improved approach to implement a solution that addresses the issues identified above.

### SUMMARY

Some embodiments of the invention provide an approach to use an intermediate OS (operating system) user to prevent lateral movement of cloud service operators among databases that share a database binary. Some embodiments use an on-demand secure communications channel to access a cloud-related resource that is associated with a customer. This creates on a temporary basis the infrastructure (including the intermediate OS user) that is needed to allow the operational access to the customer system, which can then be destroyed once it is no longer needed.

Further details of aspects, objects, and advantages of the invention are described below in the detailed description, drawings, and claims. Both the foregoing general description and the following detailed description are exemplary and explanatory, and are not intended to be limiting as to the scope of the invention.

### BRIEF DESCRIPTION OF THE FIGURES

The drawings illustrate the design and utility of some embodiments of the present invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 provides a high-level illustration of the invention according to some embodiments of the invention.

FIG. 2 shows a flowchart of an approach to implements some embodiments of the invention.

FIG. 3 shows the hierarchy of users and entities that are involved in a workflow.

FIG. 4 shows a more detailed flowchart of an approach to implement some embodiments of the invention.

FIG. 5 is a block diagram of an illustrative computing system suitable for implementing an embodiment of the present invention.

FIG. 6 is a block diagram of one or more components of a system environment in which services may be offered as cloud services, in accordance with an embodiment of the present invention.

### DETAILED DESCRIPTION OF THE EMBODIMENTS OF THE INVENTION

Various embodiments are described hereinafter with reference to the figures. It should be noted that the figures are not necessarily drawn to scale. It should also be noted that the figures are only intended to facilitate the description of the embodiments, and are not intended as an exhaustive description of the invention or as a limitation on the scope of the invention. In addition, an illustrated embodiment need not have all the aspects or advantages shown. An aspect or an advantage described in conjunction with a particular embodiment is not necessarily limited to that embodiment and can be practiced in any other embodiments even if not so illustrated. Also, reference throughout this specification to “some embodiments” or “other embodiments” means that a particular feature, structure, material, or characteristic described in connection with the embodiments is included in at least one embodiment. Thus, the appearances of the phrase “in some embodiments” or “in other embodiments,” in various places throughout this specification are not necessarily referring to the same embodiment or embodiments.

Some embodiments of the invention provide an approach to use an intermediate OS (operating system) user to prevent lateral movement of cloud service operators among databases that share a database binary. Some embodiments use an on-demand secure communications channel to access a cloud-related resource that is associated with a customer. This creates on a temporary basis the infrastructure (including the intermediate OS user) that is needed to allow the operational access to the customer system, which can then be destroyed once it is no longer needed.

The inventive concepts are particularly useful in a system that uses an on-demand secure communications channel to a cloud-related resource, where the on-demand channel provides access to the resource for a cloud provider's operator employees. This creates on a temporary basis all of the infrastructure that is needed to allow the operation access to the customer system, which can then be destroyed once it is no longer needed. The on-demand channel would be created from the direction of the client/customer to the cloud to facilitate such channels even if the client/customer system does not allow incoming connections from the cloud.

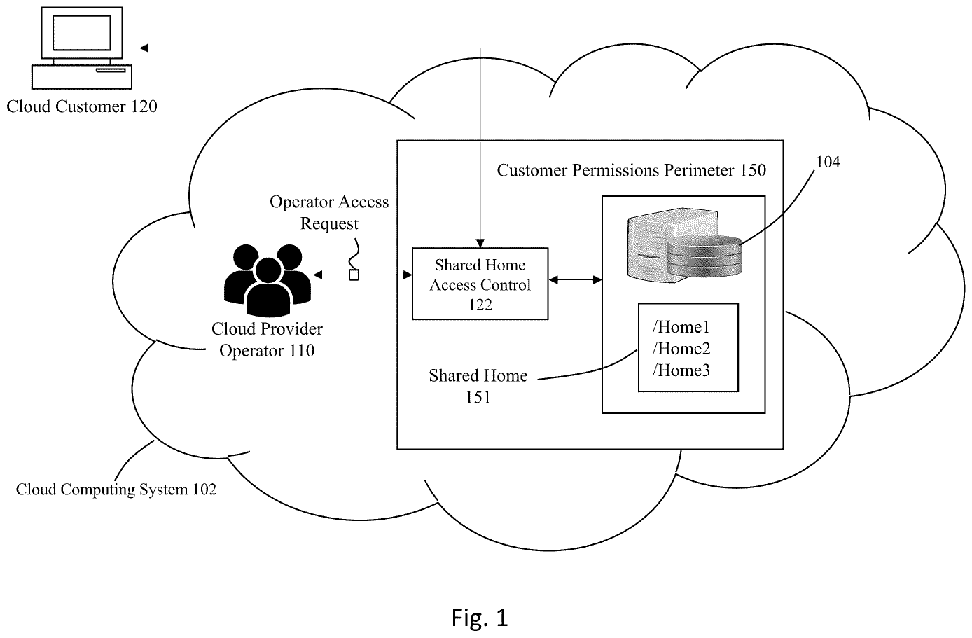

FIG. 1 provides a high-level illustration of an operator access control mechanism according to some embodiments of the invention. This figure shows a cloud computing system 102 that includes one or more cloud infrastructure resources 104 that are used by one or more cloud customers 120.

The cloud infrastructure resources 104 correspond to any type of infrastructure resource that may be allocated and used within a cloud computing environment. In some embodiments, the resources may include a shared binary approach, in which each of multiple different customers are associated with different respective “/home” directories for their software, but where the software binaries themselves are actually shared between the different customers within a shared home 151. For a database cloud provider, having a shared home can be used to maximize the number of database instances that can be published to the customers.

In this cloud deployment model, the customer may be responsible for the application/user-space level activities on the device, e.g., the operation and implementation of virtual machines, and/or the management of database management software that reside on machine. However, the cloud provider is responsible for management of the infrastructure components for that device (e.g., chassis power, bare metal operating system, hypervisors, storage services, networking services, etc.). In the conventional implementations of these models, the customer has unfettered access to components they are responsible for, and the cloud provider's employee administrators have unfettered access to components that the cloud provider is responsible for. While this model works for some portions of the cloud market, this model works poorly, or does not work at all, for regulated customers, such as banks and medical providers. As previously noted, the primary reason for this problem is that a regulated customer is responsible for controlling the actions on every aspect of the system supporting their applications, and this responsibility is independent of the owner of the equipment or the origin of the staff performing actions on said equipment. Moreover, regulated customers often have to prove to their regulators that they are in complete control of these systems, and that they are operating their systems in compliance with those regulations.

The issue addressed by the current disclosure is that a database cloud service may share the same database binary to run multiple databases. This is done to save on local storage, given that database binary file sizes can be very large. In addition, this shared approach is also useful for recovery purposes, since a backup copy is normally kept for each database software binary image, and hence a shared image reduces the volume of resources needed to create and store such backups. Also, in order to reduce the number of users created on a VM-- since each user that exists on the VM can be used as an attack vector by an attacker-- cloud services will use the same user credentials to install multiple database software binaries (e.g., since this way results in the situation where there is only one user to monitor and protect.)

However, using the same user to install the database software or the same shared binary image may create a significant drawback. When different DB (database) instances sharing the same binary image are owned by the same OS user, then the OS authenticated user connecting to one database instance can impact the other instances given that the database will often allow for file and network access from the database.

Some embodiments provide a shared home operator access control 122 that provides governance to operator access to customer resources (e.g., virtual machine or VM resources) that host databases, and prevents such lateral movement among databases in the absence of root privileges granted to the operator. In some embodiments, the access control mechanism 122 can be provided that allows a cloud customer 120 to implement customer control over access to the cloud infrastructure resources 104 by cloud provider operators 110, and further restricts the ability to access the underlying DB resources. As described in more detail below, the access controls 122 provides guard rails so that for non-root access granted to a VM hosting multiple databases, the customer can control the operator access to a selected set of databases.

In general, the shared home operator access control 122 operates by creating different sets of users for a given operator access request, where each descending level of user type provides ever lower levels of access privileges.

In some embodiments, there are three different levels of users that are associated with the operator, including an OS proxy user, an OS intermediate user, and a low privileged database user.

With respect to the OS proxy user, the system ensures that the operator logs on to the VM or the resource endpoint being managed by the cloud service using an OS Proxy user which is always controlled by a chroot jail. This ensures the operator when connected to the VM cannot issue any OS commands or access any directories that they are not authorized to do. This user does not have the privileges to connect to any database directly, and can only call a specific program (or a wrapper script) that allows them access to a named database.

The OS intermediate user is the user that is accessed by calling a program or script as the OS proxy user. This is configured as a password-less user, so that the operator cannot directly connect to the VM as the OS Intermediate User but instead must connect through a program or script. This user can do nothing other than call the client that connects to the database. This user has even lower privileges than the OS proxy user with respect to OS commands that it can execute or directories/files it can access.

The low privileged database user is the user that is accessed by calling a client to the database, e.g., a SQL*Plus client. This user has only limited privileges with respect to the database being accessed. This means that it is not possible for this user to break out of the database and access OS file system or perform lateral movement from one database to another (via database link or calling other programs like utl_http that allows a connected user to access http endpoints from the database). In some embodiments, the low privileged database user can only access certain designated database tables and/or their respective logs, e.g., based upon tables assigned though an ACP.

The access controls 122 are therefore usable to: (a) prevent the operator from using OS authentication to connect to the database; (b) prevent the operator from using a client (like SQL*Plus) that is owned by the same OS user that also owns the DB binary; (c) the operator runs the client (such as SQL*Plus) as a low privileged OS user; (d) the operator connects to the database instance using a low privileged database user, where the low privileged OS user is a no-password user, so that no operator can take on the identity of this user other than root; and/or (e) the password for the low privileged database user should be rotated once the operator session is terminated, so as to prevent the operator from using the low privileged database user's password in some other ways (e.g., using a direct JDBC connection to the database).

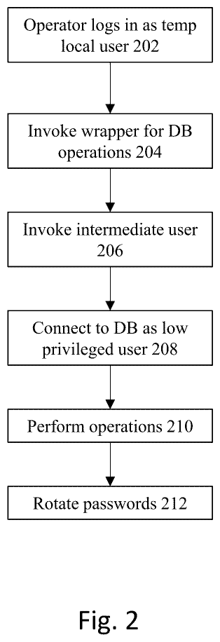

FIG. 2 shows a flowchart of an approach to implements some embodiments of the invention, where this approach uses an intermediate password-less OS user who brokers the SQL connection to the database instance, and with additional safeguards prevents potential dangerous lateral movement.

At 202, the operator logs in using a temporary local user, e.g., using a chroot jail as described in more detail below. This chroot jail makes any database client owned by the OS user that also owns the DB Binary inaccessible to the local user.

At 204, a wrapper is invoked, where the wrapper corresponds to a script that invokes the database client. The invention may be used in conjunction with any database client. For purposes of illustration, the current illustrative embodiment is described with respect to SQL*Plus.

SQL*Plus is an interactive and batch query tool that is installed with database products such as an Oracle Server or a database client installation. It has a command-line user interface and/or a web-based user interface. SQL*Plus has its own commands and environment, and it provides access to the Oracle RDBMS. It allows a user to enter and execute SQL, PL/SQL, SQL*Plus and operating system commands to perform operations such as: (a) enter SQL*Plus commands to configure the SQL*Plus environment; (b) enter, edit, store, retrieve, and run SQL commands and PL/SQL blocks; (c) format, perform calculations on, store, and print from query results; (d) interact with an end user; (e) startup and shutdown a database; (f) connect to a database; (g) define variables; (h) capture errors; (i) list column definitions for any table; (j) perform database administration. A user can use SQL*Plus to generate reports interactively, to generate reports as batch processes, and to output the results to text file, to screen, or to HTML file for browsing on the Internet. The user can also generate reports dynamically using the HTML output facility of SQL*Plus in combination with server-side CGI scripts, or using the dynamic reporting capability of iSQL*Plus to run a script from a web page.

At 206, the wrapper script checks which databases the OS user is allowed to access. It then invokes SQL*Plus as an intermediate low-privileged OS user. This intermediate user is password-less, which means that a real user will not be able to connect as the intermediate user. Through the wrapper, the intermediate user only has access to its home directory, and so it cannot readily access any other sensitive directory while connected to the database with SQL*Plus.

At 208, the invocation of the script results in a connection to the database as a low privileged database user commensurate to the access privilege granted to the operator. At 210, the required operations are then performed.

At the end of the session at 212, the database user's password is rotated automatically. This is so that even if the operator had a way to copy it, they cannot use it once the session has ended.

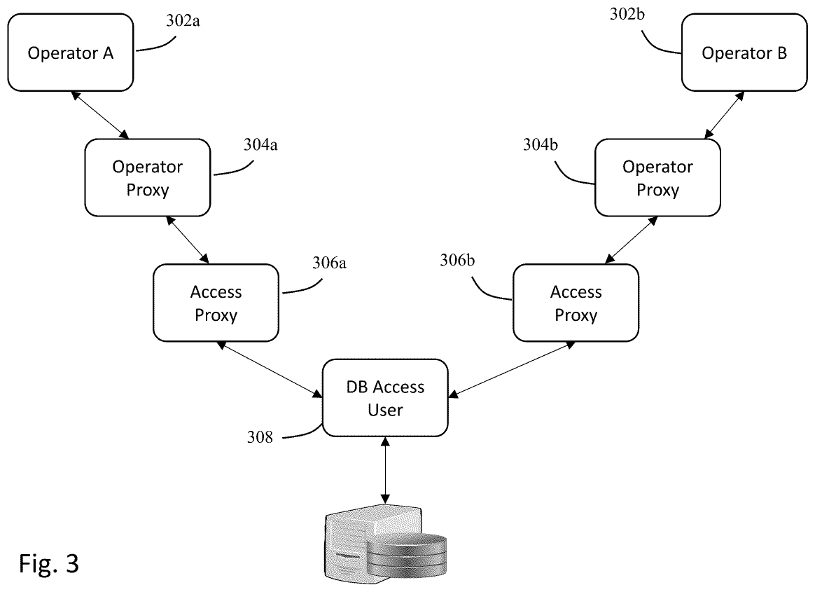

FIG. 3 shows the hierarchy of users and entities that are involved in this workflow. Operators 302a and 302b correspond to the cloud operators that will be performing administrative operations within the system. Each of these operators will initially log in and access the system as an operator proxy user 304a and 304b, respectively. The operator proxy user is the OS user created by operator access control associated with an operator for a given access request. If multiple operators share an access request, a proxy user will be created for each operator on the set of endpoints associated with the access request. It is noted that each endpoint will have the same operator proxy user for a given operator.

The operator proxy user will then execute a wrapper script to execute SQL*Plus as an access request proxy user. The access request proxy user is the OS user created by operator access control associated with a given access request. No matter how many operators are sharing the access request, only one access request proxy user will be created on the set of endpoints associated with the access request.

This switch of the operator proxy user to the access request proxy user is intended to internally shift the operator role into a very low-privileged OS user. This low privileged OS user cannot connect with a login, but instead can only call SQL*Plus in a safe mode. Therefore, this results in the creation and use of an intermediate user with very low privileges.

Here, operator 302a logged in as operator proxy user 304a, which in turn executed the wrapper script as access request proxy user 306a. Similarly, operator 302b logged in as operator proxy user 304b, which in turn executed the wrapper script as access request proxy user 306b.

Finally, the access request proxy users will access the database as a database Proxy User 308. This is the database user created for operator access control associated with an access level. The specific access level will be carefully controlled for the particular database user that is invoked by the access request proxy user. Since in some embodiments operator access control has multiple (e.g., two access levels), there can be multiple (e.g., two) DB Users created for specific access roles. For example, one DB user can be for Diagnostics level access and another for Maintenance level access. It is noted that these restricted DB users can be shared among the different operators.

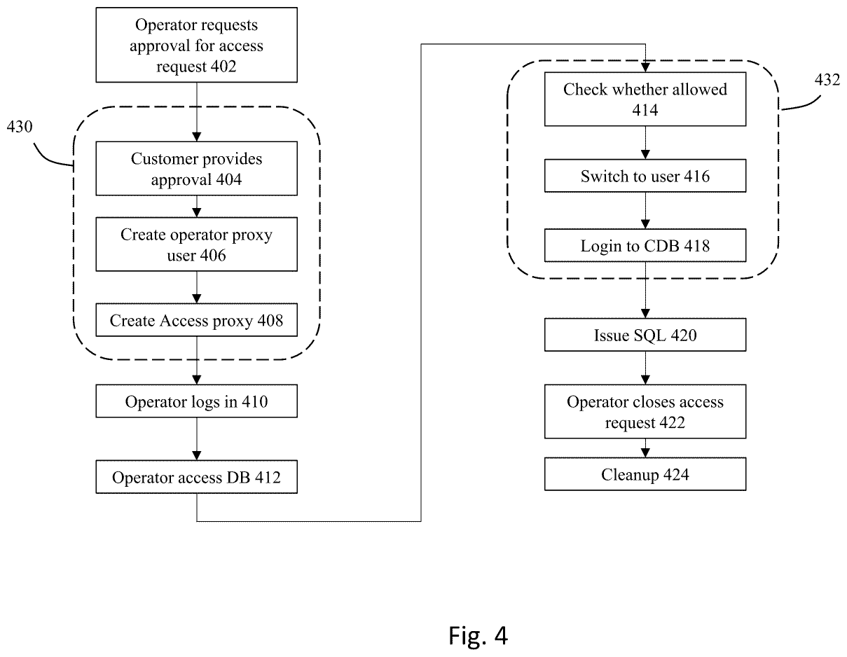

FIG. 4 shows a more detailed flowchart of an approach to implement some embodiments of the invention. For purposes of illustration, this figure is explained in the context of a multi-tenant database, where the computing architecture for the system that implements the multi-tenant database is a container database (CDB) system that provides services to clients. In this type of architecture, a CDB consolidates multiple pluggable databases (PDB), and implements a portable collection of schemas, schema objects, and non-schema objects. With this architecture, a base infrastructure is provided by the CDB as a platform to implement and host individual private databases. The private databases themselves would then be “plugged” into the CDB as individual databases for a tenant embodied as the PDBs. A container can be implemented as either a PDB or root, where the root container is a collection of schemas, schema objects, and non-schema objects to which the PDBs belong. The CDB includes a root, which stores metadata and common users. The CDB may also include a seed PDB, which is a system-supplied template that the CDB can use to create new PDBs. One or more user-created PDBs may also exist in the CDB, where the PDB corresponds to a user-created entity that contains the data and code required for a specific set of features. For example, a PDB can support a specific application, such as a human resources or sales application.

The advantage of this approach for a multi-tenant database is with regards to resource usage and database consolidation. Database consolidation is the process of consolidating data from multiple databases into one database on one computer. Using the multitenant architecture for database consolidation provides benefits for cost reduction, since by consolidating hardware and database infrastructure to a single set of background processes, and efficiently sharing computational and memory resources, this reduces costs for hardware and maintenance tasks/expenses. This also provides advantages for easier management and monitoring of the physical database, as well as efficiencies for performance tuning.

While the illustrative example that is explained herein is described in the context of a computing architecture that implements the multi-tenant database as a container database, it is noted the inventive concept is not limited only to this specific context. Indeed, the inventive concept is applicable to manage operator access for any suitable computing architecture, and is thus not limited only to the illustrative example described herein unless expressly claimed as such.

At 402, the operator will request approval to access the system. In some embodiments, the cloud customer access control mechanism creates a customer permissions perimeter that allows the cloud customer to manage the extent, timing, and approval process for access to the cloud infrastructure resources that are associated with the cloud customer. To provide the operator access, some embodiments may implement one or more access control profiles (“ACPs”) that are created in the system. These access control profiles pertain to named and pre-defined profiles of the commands/files/network which can be accessed on a given layer. In some embodiments, these profiles are established and owned by the cloud provider. The kind of control that can be enforced by ACPs defines the technology chosen to implement the possible enforcements. The enforcement can be on any level of granularity, e.g., at the user level, file system level, kernel access level, and/or on a resources level such as, for example, for a CPU or memory. The control profiles may be used to enforce a semi-sandbox state, and may enforce what a cloud operator user can access in the system. The control profiles may also be used to enforce what the cloud operator is permitted to do in the system, e.g., pertaining to execution of shell (OS) commands, operator-developed scripts, database commands, cloud tooling commands, and/or DB client tools.

In addition, one or more customer control policies (CCA policies) may be generated and/or configured. This is a customer-defined entity which contains a grouping of the access control profiles that are allowed and/or restricted. The policy may include a list of customer users who have permissions to approve/revoke access. In some embodiments, the CCA policy may define criteria for the users who may access the infrastructure. This could be due to, for example, legal requirements of the customer's industry and/or contractual requirements imposed upon the customer. In some embodiments, the CCA policy is created by a customer with some or all of the following attributes: (a) policy name, where the policy name should be a unique name within the tenancy; (b) identification of customer users with approval rights, which are the rights to approve access requests; (c) a policy description; (d) user attributes of the policy, which pertain to rules for the users who will request access; (e) ACPs which are automatically approved as per the policy, and in which ACPs not explicitly allowed will require approval; and/or (f) policies that are audit-only, where all ACPs are allowed automatically with only access logging enabled. One or more policies may be deployed within the system, where this is the action by which the one or more policies are associated with cloud resources within the system. Once the policy has been deployed, any operator access to the resource will be governed by the policy. The deployment can be of any length of time, e.g., made permanent or for only a specific duration.

To manage access by operators, the operators may submit an operator access request for access to a cloud resource. In some embodiments, the request includes one or more of the following: (a) the identifier of the specific resource for which access is requested; (b) the ACP that is being requested by the operator; (c) the time duration for the request; and/or (d) for auditing purposes, the reason for which the request is being made. In normal operation, the operator request can be checked against the polic(ies) that are pertinent to the request, where aa determination is made whether the automatic approval can be made for the access request. With certain embodiments of the invention, distinctions are made between different types of requests, where certain requests are deemed appropriate for automatic processing, while other requests are deemed appropriate for explicit customer approvals. For example, certain types of ACPs that pertain to read-only access of non-sensitive system information may be designated as eligible for automatic approvals (subject to logging as described in more detail below). However, other types of access to more sensitive information or activities may require explicit customer approval.

At 404, the customer may provide approval for the request. The approval may be provided manually, or automatically based upon a policy criteria/analysis. At 406, an operator proxy user is created for the operator to use to access the system.

In some embodiments, upon approval for the operator access, a temporary user account is created for the operator access on the target resource. For example, in some systems, a new user (e.g., a Linux user) can be created on the target resource. The user is created to ensure clear access control and auditability for the operator user actions. As the user is created as a new temporary account, there is no existing privilege in the system. The user is deleted once the access expires and hence it is a clear removal of privilege. A chroot environment can be created for the temporary user account. A chroot on a Unix-based operating system (such as Linux) is an operation that changes the apparent root directory for the current running process and its children. The programs that run in this modified environment cannot access the files outside the designated directory tree. This essentially limits their access to a directory tree and thus they get the name “chroot jail”. This means that the cloud operator will only be able to perform its activities within the scope of the directory tree for the chroot environment that is created for the temporary user account. The operator will now be permitted to access the cloud resource using a temporary username that has been created for the operator using the operator's public key. For example, the operator may use a secure shell (SSH) to perform key-based log-in to access to the cloud resource using the temporary username that has been created for the operator. Thereafter, the operator will be permitted to perform the activities permitted by the corresponding ACP. For example, the allowed activities may include a defined set of commands executable by the operator user. These commands could be direct like issuing a “ls” on the linux machine or indirect like a shell script executed which invokes “ls”. Activities are limited to this definition and not further such as syscalls invoked or the libraries invoked by the user. It is possible that in some cases there is a delegated execution where a command is executed by the user which submits a request to a daemon running on the system. This daemon performs the command on behalf of the user. These also will be logged. At the expiry of the time duration for the operator access, the system deletes the temporary user from the target endpoint. This action may also occur upon an explicit action by the customer to revoke access. This will remove the ability of the operator to access the system.

As noted above, OS authenticated connection to such database instances may allow the operators to move laterally from one database to the other (as the binary images are owned by the same OS user). The additional actions described below provide a shared home operator access control that implements governance to operator access to customer resources (e.g., virtual machine or VM resources) that host databases, and prevents such lateral movement among databases in absence of the root privilege granted to the operator. Therefore, after the operator proxy is created at 406, an access proxy is created at 408 on one or more nodes of the system.

At 410, the operator now logs in as the operator proxy. To access the database at 412, the call the wrapper script (which may be referred to herein as “execsql”). At 414, a check is made whether this access is permitted. For example, permissions levels may be checked to determine whether the execution of the wrapper script is permitted.

At 416, a switch is made to the access proxy user. This is the switch that occurs to a low privileged OS user within the system for the operator. This low-privileged user can thus only be accessed by using the limited wrapper script in the previous step.

At this point, at 418, a login to the DB will occur as the limited-role DB user. The limited-role DB user is restricted to only certain actions or tasks. For example, the DB user may be restricted to performing only certain diagnostics tasks, or another DB user may be restricted to only certain maintenance-related tasks. At 420, the DB user issue commands, e.g., SQL commands, to perform the desired tasks.

Once the desired tasks are completed, then at 422, the operator will close the access request. At this point, at 424, cleanup activities will occur in the system. For example, the operator proxy user and the access proxy users may be deleted at this point. In addition, the password for the DB user may be rotated.

All of these activities by the operator user may be logged by the system. The activity monitoring is performed through audit logs generated for the activities performed by the operator, with logs being made available to the customer. One aspect of the monitoring is the ability to post the monitor logs to the customer. In some embodiments, the posted logs will include one, some or all of the following information: (a) identifier of the resource from where the logs are generated; (b) layer from which the logs are generated; (c) the user ID generating the log; (d) the access request ID which granted the access; (e) timestamp of the log. Various types of logging may be implemented, including for example, one or more of the following: (a) keystroke logging; (b) capture of all OS commands and/or DB commands executed by operator; (c) logging of all commands executed through a script; and/or (d) logging of commands executed by a delegate (such as a daemon). The time interval may be configured as desired for the logging, e.g., with small time intervals such that the logging is in near-realtime.

In some embodiments, it is noted that the actions grouped in blocks 430 and 432 are system-based actions, as opposed to operator-based actions such as the other computing blocks. As such, within block 430, actions 404, 406, and 408 are performed by the system, and likewise in block 432, actions 4124, 416, and 418 are also performed by the system.

Therefore, what has been described is an improved approach to implement operator access in a multi-tenant system.

### System Architecture

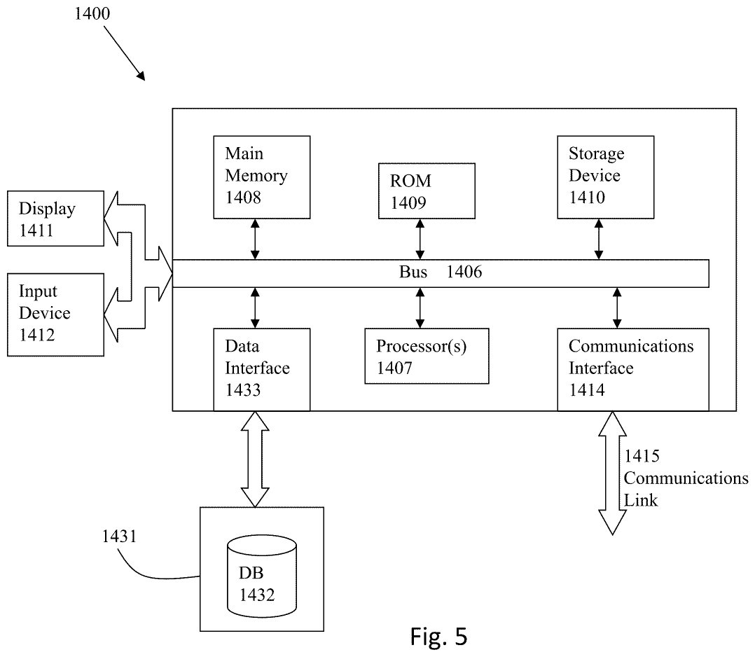

FIG. 5 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to some embodiments of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In some embodiments, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1410 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution. A database 1432 in a storage medium 1431 may be used to store data accessible by the system 1400.

The techniques described may be implemented using various processing systems, such as clustered computing systems, distributed systems, and cloud computing systems. In some embodiments, some or all of the data processing system described above may be part of a cloud computing system. Cloud computing systems may implement cloud computing services, including cloud communication, cloud storage, and cloud processing.

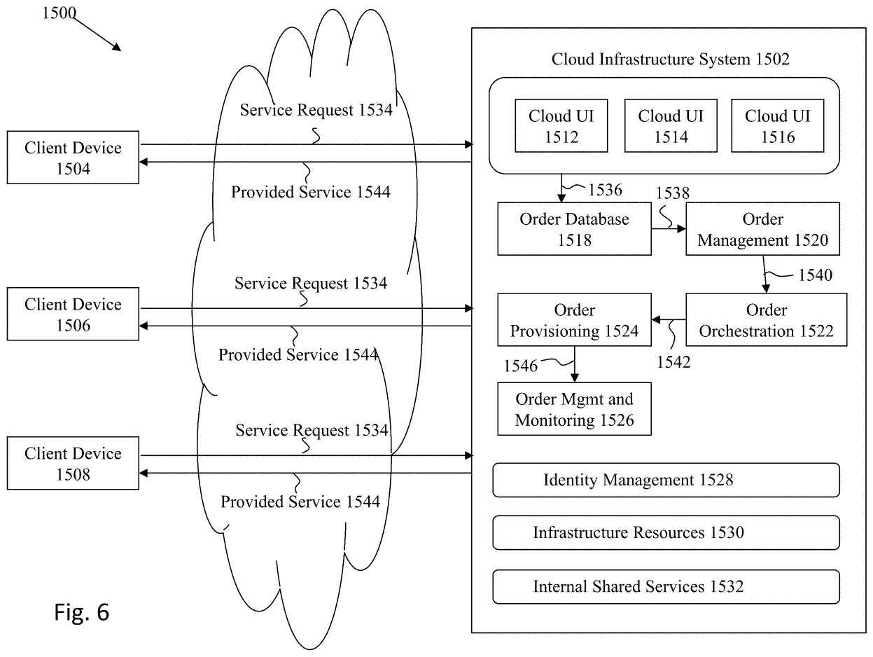

FIG. 6 is a simplified block diagram of one or more components of a system environment 1500 by which services provided by one or more components of an embodiment system may be offered as cloud services, in accordance with an embodiment of the present disclosure. In the illustrated embodiment, system environment 1500 includes one or more client computing devices 1504, 1506, and 1508 that may be used by users to interact with a cloud infrastructure system 1502 that provides cloud services. The client computing devices may be configured to operate a client application such as a web browser, a proprietary client application, or some other application, which may be used by a user of the client computing device to interact with cloud infrastructure system 1502 to use services provided by cloud infrastructure system 1502.

It should be appreciated that cloud infrastructure system 1502 depicted in the figure may have other components than those depicted. Further, the embodiment shown in the figure is only one example of a cloud infrastructure system that may incorporate an embodiment of the invention. In some other embodiments, cloud infrastructure system 1502 may have more or fewer components than shown in the figure, may combine two or more components, or may have a different configuration or arrangement of components.

Client computing devices 1504, 1506, and 1508 may be devices similar to those described above for FIG. 6. Although system environment 1500 is shown with three client computing devices, any number of client computing devices may be supported. Other devices such as devices with sensors, etc. may interact with cloud infrastructure system 1502.

Network(s) 1510 may facilitate communications and exchange of data between clients 1504, 1506, and 1508 and cloud infrastructure system 1502. Each network may be any type of network familiar to those skilled in the art that can support data communications using any of a variety of commercially-available protocols. Cloud infrastructure system 1502 may comprise one or more computers and/or servers.

In certain embodiments, services provided by the cloud infrastructure system may include a host of services that are made available to users of the cloud infrastructure system on demand, such as online data storage and backup solutions, Web-based e-mail services, hosted office suites and document collaboration services, database processing, managed technical support services, and the like. Services provided by the cloud infrastructure system can dynamically scale to meet the needs of its users. A specific instantiation of a service provided by cloud infrastructure system is referred to herein as a “service instance.” In general, any service made available to a user via a communication network, such as the Internet, from a cloud service provider's system is referred to as a “cloud service.” Typically, in a public cloud environment, servers and systems that make up the cloud service provider's system are different from the customer's own on-premises servers and systems. For example, a cloud service provider's system may host an application, and a user may, via a communication network such as the Internet, on demand, order and use the application.

In some examples, a service in a computer network cloud infrastructure may include protected computer network access to storage, a hosted database, a hosted web server, a software application, or other service provided by a cloud vendor to a user, or as otherwise known in the art. For example, a service can include password-protected access to remote storage on the cloud through the Internet. As another example, a service can include a web service-based hosted relational database and a script-language middleware engine for private use by a networked developer. As another example, a service can include access to an email software application hosted on a cloud vendor's web site.

In certain embodiments, cloud infrastructure system 1502 may include a suite of applications, middleware, and database service offerings that are delivered to a customer in a self-service, subscription-based, elastically scalable, reliable, highly available, and secure manner.

In various embodiments, cloud infrastructure system 1502 may be adapted to automatically provision, manage and track a customer's subscription to services offered by cloud infrastructure system 1502. Cloud infrastructure system 1502 may provide the cloud services via different deployment models. For example, services may be provided under a public cloud model in which cloud infrastructure system 1502 is owned by an organization selling cloud services and the services are made available to the general public or different industry enterprises. As another example, services may be provided under a private cloud model in which cloud infrastructure system 1502 is operated solely for a single organization and may provide services for one or more entities within the organization. The cloud services may also be provided under a community cloud model in which cloud infrastructure system 1502 and the services provided by cloud infrastructure system 1502 are shared by several organizations in a related community. The cloud services may also be provided under a hybrid cloud model, which is a combination of two or more different models.

In some embodiments, the services provided by cloud infrastructure system 1502 may include one or more services provided under Software as a Service (SaaS) category, Platform as a Service (PaaS) category, Infrastructure as a Service (IaaS) category, or other categories of services including hybrid services. A customer, via a subscription order, may order one or more services provided by cloud infrastructure system 1502. Cloud infrastructure system 1502 then performs processing to provide the services in the customer's subscription order.

In some embodiments, the services provided by cloud infrastructure system 1502 may include, without limitation, application services, platform services and infrastructure services. In some examples, application services may be provided by the cloud infrastructure system via a SaaS platform. The SaaS platform may be configured to provide cloud services that fall under the SaaS category. For example, the SaaS platform may provide capabilities to build and deliver a suite of on-demand applications on an integrated development and deployment platform. The SaaS platform may manage and control the underlying software and infrastructure for providing the SaaS services. By utilizing the services provided by the SaaS platform, customers can utilize applications executing on the cloud infrastructure system. Customers can acquire the application services without the need for customers to purchase separate licenses and support. Various different SaaS services may be provided. Examples include, without limitation, services that provide solutions for sales performance management, enterprise integration, and business flexibility for large organizations.

In some embodiments, platform services may be provided by the cloud infrastructure system via a PaaS platform. The PaaS platform may be configured to provide cloud services that fall under the PaaS category. Examples of platform services may include without limitation services that enable organizations to consolidate existing applications on a shared, common architecture, as well as the ability to build new applications that leverage the shared services provided by the platform. The PaaS platform may manage and control the underlying software and infrastructure for providing the PaaS services. Customers can acquire the PaaS services provided by the cloud infrastructure system without the need for customers to purchase separate licenses and support.

By utilizing the services provided by the PaaS platform, customers can employ programming languages and tools supported by the cloud infrastructure system and also control the deployed services. In some embodiments, platform services provided by the cloud infrastructure system may include database cloud services, middleware cloud services, and Java cloud services. In one embodiment, database cloud services may support shared service deployment models that enable organizations to pool database resources and offer customers a Database as a Service in the form of a database cloud. Middleware cloud services may provide a platform for customers to develop and deploy various business applications, and Java cloud services may provide a platform for customers to deploy Java applications, in the cloud infrastructure system.

Various different infrastructure services may be provided by an IaaS platform in the cloud infrastructure system. The infrastructure services facilitate the management and control of the underlying computing resources, such as storage, networks, and other fundamental computing resources for customers utilizing services provided by the SaaS platform and the PaaS platform.

In certain embodiments, cloud infrastructure system 1502 may also include infrastructure resources 1530 for providing the resources used to provide various services to customers of the cloud infrastructure system. In one embodiment, infrastructure resources 1530 may include pre-integrated and optimized combinations of hardware, such as servers, storage, and networking resources to execute the services provided by the PaaS platform and the SaaS platform.

In some embodiments, resources in cloud infrastructure system 1502 may be shared by multiple users and dynamically re-allocated per demand. Additionally, resources may be allocated to users in different time zones. For example, cloud infrastructure system 1502 may enable a first set of users in a first time zone to utilize resources of the cloud infrastructure system for a specified number of hours and then enable the re-allocation of the same resources to another set of users located in a different time zone, thereby maximizing the utilization of resources.

In certain embodiments, a number of internal shared services 1532 may be provided that are shared by different components or modules of cloud infrastructure system 1502 and by the services provided by cloud infrastructure system 1502. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

In certain embodiments, cloud infrastructure system 1502 may provide comprehensive management of cloud services (e.g., SaaS, PaaS, and IaaS services) in the cloud infrastructure system. In one embodiment, cloud management functionality may include capabilities for provisioning, managing and tracking a customer's subscription received by cloud infrastructure system 1502, and the like.

In one embodiment, as depicted in the figure, cloud management functionality may be provided by one or more modules, such as an order management module 1520, an order orchestration module 1522, an order provisioning module 1524, an order management and monitoring module 1526, and an identity management module 1528. These modules may include or be provided using one or more computers and/or servers, which may be general purpose computers, specialized server computers, server farms, server clusters, or any other appropriate arrangement and/or combination.

In operation 1534, a customer using a client device, such as client device 1504, 1506 or 1508, may interact with cloud infrastructure system 1502 by requesting one or more services provided by cloud infrastructure system 1502 and placing an order for a subscription for one or more services offered by cloud infrastructure system 1502. In certain embodiments, the customer may access a cloud User Interface (UI), cloud UI 1512, cloud UI 1514 and/or cloud UI 1516 and place a subscription order via these UIs. The order information received by cloud infrastructure system 1502 in response to the customer placing an order may include information identifying the customer and one or more services offered by the cloud infrastructure system 1502 that the customer intends to subscribe to.

After an order has been placed by the customer, the order information is received via the cloud UIs, 1512, 1514 and/or 1516. At operation 1536, the order is stored in order database 1518. Order database 1518 can be one of several databases operated by cloud infrastructure system 1518 and operated in conjunction with other system elements. At operation 1538, the order information is forwarded to an order management module 1520. In some instances, order management module 1520 may be configured to perform billing and accounting functions related to the order, such as verifying the order, and upon verification, booking the order. At operation 1540, information regarding the order is communicated to an order orchestration module 1522. Order orchestration module 1522 may utilize the order information to orchestrate the provisioning of services and resources for the order placed by the customer. In some instances, order orchestration module 1522 may orchestrate the provisioning of resources to support the subscribed services using the services of order provisioning module 1524.

In certain embodiments, order orchestration module 1522 enables the management of business processes associated with each order and applies business logic to determine whether an order should proceed to provisioning. At operation 1542, upon receiving an order for a new subscription, order orchestration module 1522 sends a request to order provisioning module 1524 to allocate resources and configure those resources needed to fulfill the subscription order. Order provisioning module 1524 enables the allocation of resources for the services ordered by the customer. Order provisioning module 1524 provides a level of abstraction between the cloud services provided by cloud infrastructure system 1502 and the physical implementation layer that is used to provision the resources for providing the requested services. Order orchestration module 1522 may thus be isolated from implementation details, such as whether or not services and resources are actually provisioned on the fly or pre-provisioned and only allocated/assigned upon request.

At operation 1544, once the services and resources are provisioned, a notification of the provided service may be sent to customers on client devices 1504, 1506 and/or 1508 by order provisioning module 1524 of cloud infrastructure system 1502.

At operation 1546, the customer's subscription order may be managed and tracked by an order management and monitoring module 1526. In some instances, order management and monitoring module 1526 may be configured to collect usage statistics for the services in the subscription order, such as the amount of storage used, the amount data transferred, the number of users, and the amount of system up time and system down time.

In certain embodiments, cloud infrastructure system 1502 may include an identity management module 1528. Identity management module 1528 may be configured to provide identity services, such as access management and authorization services in cloud infrastructure system 1502. In some embodiments, identity management module 1528 may control information about customers who wish to utilize the services provided by cloud infrastructure system 1502. Such information can include information that authenticates the identities of such customers and information that describes which actions those customers are authorized to perform relative to various system resources (e.g., files, directories, applications, communication ports, memory segments, etc.) Identity management module 1528 may also include the management of descriptive information about each customer and about how and by whom that descriptive information can be accessed and modified.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

What is claimed is:

1. A method, comprising:
receiving a request to establish a connection for an operator to access a computing system to access a cloud computing database resource that is associated with one or more cloud users;
creating an OS proxy user to access the cloud computing system by the operator;
creating an intermediate OS proxy user that is accessed by the OS proxy user, wherein the intermediate OS proxy user has limited rights; and
using the intermediate OS proxy user to log in as a limited-rights database user to access the cloud computing database resource.

2. The method of claim 1, wherein the intermediate OS proxy user is accessed by the OS proxy user by calling a wrapper script.

3. The method of claim 1, wherein the intermediate OS proxy user is not accessed by the OS proxy user by using a password.

4. The method of claim 1, wherein the limited-rights database user is restricted to perform a limited number of actions with respect to the cloud computing database resource.

5. The method of claim 1, wherein the cloud computing database resource that is operated upon by the operator is a shared binary image that is shared among multiple cloud users.

6. The method of claim 1, wherein the OS proxy user and the intermediate OS proxy user are both destroyed after the operator has completed its requested access to the cloud computing database resource.

7. The method of claim 1, wherein a password to log in as the limited-rights database user is rotated after the operator has completed its requested access to the cloud computing database resource.

8. A computer program product embodied on a computer readable medium, the computer readable medium having stored thereon a sequence of instructions which, when executed by a processor, executes a method comprising:
receiving a request to establish a connection for an operator to access a computing system to access a cloud computing database resource that is associated with one or more cloud users;
creating an OS proxy user to access the cloud computing system by the operator;
creating an intermediate OS proxy user that is access by the OS proxy user, wherein the intermediate OS proxy user has limited rights; and
using the intermediate OS proxy user to log in as a limited-rights database user to access the cloud computing database resource.

9. The computer program product of claim 8, wherein the intermediate OS proxy user is accessed by the OS proxy user by calling a wrapper script.

10. The computer program product of claim 8, wherein the intermediate OS proxy user is not accessed by the OS proxy user by using a password.

11. The computer program product of claim 8, wherein the limited-rights database user is restricted to perform a limited number of actions with respect to the cloud computing database resource.

12. The computer program product of claim 8, wherein the cloud computing database resource that is operated upon by the operator is a shared binary image that is shared among multiple cloud users.

13. The computer program product of claim 8, wherein the OS proxy user and the intermediate OS proxy user are both destroyed after the operator has completed its requested access to the cloud computing database resource.

14. The computer program product of claim 8, wherein a password to log in as the limited-rights database user is rotated after the operator has completed its requested access to the cloud computing database resource.

15. A system, comprising:
a processor;
a memory for holding programmable code; and
wherein the programmable code includes instructions executable by the processor for receiving a request to establish a connection for an operator to access a computing system to access a cloud computing database resource that is associated with one or more cloud users; creating an OS proxy user to access the cloud computing system by the operator; creating an intermediate OS proxy user that is access by the OS proxy user, wherein the intermediate OS proxy user has limited rights; and using the intermediate OS proxy user to log in as a limited-rights database user to access the cloud computing database resource.

16. The system of claim 15, wherein the intermediate OS proxy user is accessed by the OS proxy user by calling a wrapper script.

17. The system of claim 15, wherein the intermediate OS proxy user is not accessed by the OS proxy user by using a password.

18. The system of claim 15, wherein the limited-rights database user is restricted to perform a limited number of actions with respect to the cloud computing database resource.

19. The system of claim 15, wherein the cloud computing database resource that is operated upon by the operator is a shared binary image that is shared among multiple cloud users.

20. The system of claim 15, wherein the OS proxy user and the intermediate OS proxy user are both destroyed after the operator has completed its requested access to the cloud computing database resource.

21. The system of claim 15, wherein a password to log in as the limited-rights database user is rotated after the operator has completed its requested access to the cloud computing database resource.
